(19) United States
(12) Patent Application Publication
(10) Pub. No.: US 2017/0042181 A1
(43) Pub. Date: Feb. 16, 2017

(54) ICE MACHINE FOR DISPENSING FLAVORED ICE CUBES AND METHODS OF MAKING FLAVORED ICE CUBES

(71) Applicant: Ice Pro Systems, LLC, Port St. Lucie, FL (US)

(72) Inventor: Robert J. Fiaschi, Port St. Lucie, FL (US)

(21) Appl. No.: 15/337,631

(22) Filed: Oct. 28, 2016

Related U.S. Application Data
(63) Continuation-in-part of application No. 13/357,660, filed on Jan. 25, 2012.
(60) Provisional application No. 61/435,990, filed on Jan. 25, 2011.

(51) Int. Cl. A23G 9/28; A23F 3/40; A23F 5/46; A23L 2/56

(52) U.S. Cl. CPC A23G 9/281; A23L 2/56; A23F 3/40; A23F 5/46; A23V 2002/00

(57) ABSTRACT

A device and method for producing flavored ice cubes. The device comprises an upper portion and a lower portion. The upper portion comprises the internal parts of the ice machine for dispensing flavored ice cubes that produces the flavored ice, including a beverage holding tank to hold one or more beverages. Coupled to the beverage holding tank is a fill channel for transporting the beverage from a first location to the tank, and for re-circulating melted flavored ice cubes formed therein. A first supply hose fluidly connects the beverage holding tank to a pump which, when activated, transports the beverage from the beverage holding device to a pressurized supply line. After receiving the beverage, the ice maker device produces ice cubes in the flavor of the beverage and stores them in a flavored ice cube storage container.

### CROSS REFERENCE TO RELATED APPLICATION

In accordance with 37 C.F.R 1.76, a claim of priority is included in an Application Data Sheet filed concurrently herewith. Accordingly, the present invention claims priority as a continuation-in-part of U.S. patent application Ser. No. 13/357,660, filed Jan. 25, 2012, entitled “ICE MACHINE FOR DISPENSING FLAVORED ICE CUBES” which claims priority to the U. S. Provisional Application 61/435,990, filed on Jan. 25, 2011, entitled “ICE MACHINE FOR DISPENSING FLAVORED ICE CUBES”, the contents of each of the above mentioned applications are herein incorporated by reference.

### FIELD OF THE INVENTION

The instant invention relates to devices and methods which can be useful in minimizing the flavor dilution associated with cooling beverages using ice cubes; and more particularly, to devices and methods for producing and dispensing flavored ice cubes into a beverage, thereby maintaining the beverage concentration and flavor while enhancing the drinking experience by cooling the liquid to the desired temperature.

### BACKGROUND OF THE INVENTION

The beverage industry is a multi-billion dollar industry that covers a plurality of beverage types, including carbonated soft-drinks, fruit beverages, functional drinks (i.e. energy drinks), sports drinks, alcohol drinks, and coffee and tea drinks. A 2010 survey taken by a beverage industry trade magazine indicated that a large amount of companies that participated in the survey plan to develop new sports drinks, energy drinks, flavored waters, juice and juice drinks. Reasons cited for the business plan to develop such drinks include consumer demand, a desire to increase sales, and providing varieties to their consumers. One of the key components of developing new beverages is the introduction of new flavors and color varieties. Maintaining the beverage's flavor and appearance, therefore, is vital to the consumer enjoyment and development of brand loyalty.

Most beverages are typically sold in either beverage containers, such as cans or bottles, or are dispensed from beverage dispensing machines, such as those typically found at convenience stores, movie theaters, and restaurants. In either means, users typically enjoy their beverages cold. While it may be preferable for companies to sell their drinks cold, thereby maintaining their original flavor and appearance, due to limited space and the expense of refrigeration, not all drinks can be sold in this manner. Moreover, while a refrigerated drink may initially maintain its temperature through insulated containment, the cooled beverage will lose its temperate the longer it remains at room temperature or in a non-cooled state.

An economical and easy means to retain the beverage's cold temperature is the use of ice cubes. Typical beverage dispensers, therefore, contain beverage dispensing means as well as a means for dispensing ice. For example, a typical restaurant will contain a beverage device that dispenses one or more varieties of soft drinks, lemonades, teas, and fruit drinks. In addition, one or more ice dispensing means is also available for ice that is either made by the machine itself or through dispensing ice made at a different location and adding it to the device. Once the ice is dispensed into the beverage, it functions to cool the beverage. As soon as the ice interacts with the beverage, the ice begins to dissolve. While some insulating cups retard such action, eventually the ice will melt, placing the contents of the ice cube, i.e. water, into the drink. Eventually a large amount of ice cubes will melt, causing the original concentration of the drink to become diluted. Such dilution results in a “watered-down” beverage, resulting in a drink that no longer tastes the same as the original drink was intended.

### DESCRIPTION OF THE PRIOR ART

Devices for dispensing flavored beverages are known in the art. For example, U.S. Pat. No. 7,428,824 describes a vending machine which has a selector for a plurality of beverage types and a selector for a plurality of ice types. The vending machine has a first storage area for storing a supply of the plurality of beverage types and a second storage area for storing a supply of the plurality of ice types. The vending machine also has a dispenser for dispensing a selected beverage type and a selected ice type into a container.

United States Patent Application 2010/0223946 describes an appliance for dispensing beverages which includes a brewing unit through which hot water can flow for extraction, a beverage dispenser coupled to the brewing unit to dispense a prepared beverage into a container, a cooling device to supply ice for cooling a beverage, and a dosage device for ice cubes to automatically dose ice during the beverage preparation.

United States Patent Application 2010/0199846 describes an appliance for dispensing a beverage which includes a brewing unit through which hot water can flow through an extraction substance to produce a brewed beverage. A collecting container is arranged to receive the brewed beverage from the brewing unit. A beverage dispenser is arranged to receive a prepared beverage from the collecting unit and to fill a container with the prepared beverage. A device is arranged to supply ice to the collecting container. The brewed beverage is permitted to flow through the collecting container with the ice.

United States Patent Application 2008/0066483 describes a device and methods for dispensing flavored ice drinks. The device includes one or more containers for holding a concentrated drink, water supply, a mixing unit for mixing the concentrated drink with the water into a substantially homogeneous liquid mixture, an ice making unit assembly for freezing freshly produced liquid mixture into ice cubes containing substantially identical ice quantity, a crushing and blending unit for crushing a pre-measured amount of the ice cubes into small, drinkable ice particles, and blending the ice particles with a pre-measured amount of freshly produced liquid mixture. The device also includes a vessel dispensing unit for dispensing a vessel to hold the ice drink, and a computerized control unit for controlling aspects of the process of producing the ice drink.

### SUMMARY OF THE INVENTION

The current invention embodies devices and methods for making and dispensing flavored ice cubes. The ice machine for dispensing flavored ice cubes in accordance with the instant invention is a self-contained system comprising a beverage holding tank constructed and arranged to hold one or more beverages. Coupled to the beverage holding tank is a fill channel for transporting the beverage from a first location to the tank. Melted flavored ice may be re-circulated to the beverage holding tank for refreezing. A plurality of supply hoses fluidly connect the beverage holding tank to a pump, which, when activated, pressurizes the beverage holding tank and transports the beverage from the beverage holding tank to either a preexisting pressurized supply line or a separate supply line. The preexisting pressurized supply line or the separate supply line is fluidly connected to a flavored ice forming device, such as an ice maker, which produces flavored ice cubes in the flavor of the beverage and stores them in a flavored ice storage bin.

In use, the beverage holding tank is filled with a beverage which can be transported to a device to be frozen and form flavored ice cubes. As used herein the term beverage includes drinkable, flavored liquids such as but not limited to: carbonated soft-drinks (COKE®, PEPSI®), fruit beverages (such as apple juice, cranberry juice, or lemonade), functional drinks (i.e. energy drinks that contain supplements such as vitamins or herbs, and/or stimulants), sports drinks (including protein and/or carbohydrate drinks such as GATORADE®), alcohol drinks, flavored waters, coffee and coffee-based drinks (such as espresso, frappuccino, latte, mocha, or other liquids that contain coffee) or flavored coffee drinks, tea, tea-based drinks (liquids that contain tea), or flavored tea drinks, or beverage mixtures. Flavored liquids may also be defined as a liquid that freezes at a greater temperature than the freezing point of water under the same conditions. The system is activated by engaging a device for transferring said beverage to a flavored ice forming device, such as powering a pump. The pump circulates the flavored liquid from the tank to a feed line which is pressurized to feed the liquid into an ice making machine. After the flavored ice is made, the cubes are stored in a flavored ice storage unit ready for dispensing into a beverage holding device, such as a cup, glass, or pitcher.

Accordingly, it is an objective of the present invention to provide a device that makes flavored ice cubes.

It is an objective of the present invention to provide methods of making flavored ice cubes.

It is a further objective of the present invention to provide a device that dispenses flavored ice cubes.

It is yet another objective of the instant invention to provide an ice machine for dispensing flavored ice cubes which contains a pump which is constructed and arranged to feed a flavored liquid or beverage into an existing feed line to make flavored ice cubes.

It is yet another objective of the present invention to provide a method of making flavored ice cubes within a device that contains a pump which is constructed and arranged to feed a flavored liquid or beverage into an existing feed line to make flavored ice cubes.

It is a further objective of the present invention to provide a device which contains a pump which is constructed and arranged to feed a flavored liquid or beverage into an ice making device.

It is a further objective of the present invention to provide methods of making flavored ice cubes within a device which contains a pump which is constructed and arranged to feed a flavored liquid or beverage into an ice making device.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1A is a block diagram of a portion of an illustrative example of an ice machine for dispensing flavored ice cubes in accordance with the instant invention;

FIG. 1B is a block diagram of an alternative embodiment of the ice machine for dispensing flavored ice cubes in accordance with the instant invention;

FIG. 2A is a schematic view of an illustrative embodiment of the ice machine for dispensing flavored ice cubes in accordance with the instant invention;

FIG. 2B is a schematic view of an alternative embodiment of the ice machine for dispensing flavored ice cubes in accordance with the instant invention;

FIG. 3 is a front perspective view of an alternative embodiment of the ice machine for dispensing flavored ice cubes in accordance with the instant invention;

FIG. 4 is a schematic representation of an embodiment of the ice machine for dispensing flavored ice cubes configured for dispensing or storing multiple flavored ice cubes

FIG. 5 is a schematic drawing of the ice machine for dispensing flavored ice cubes configured for dispensing or storing multiple flavored ice cubes in accordance with the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

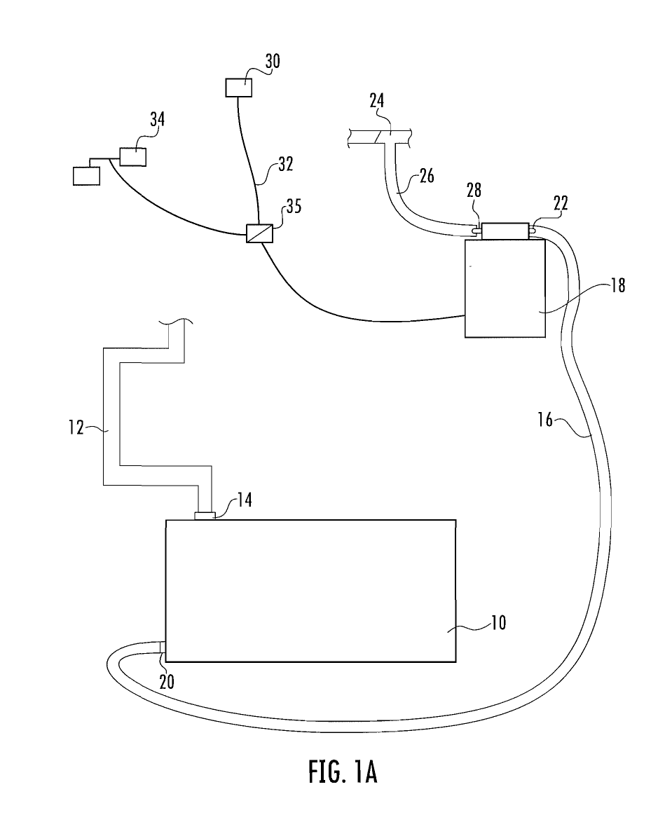

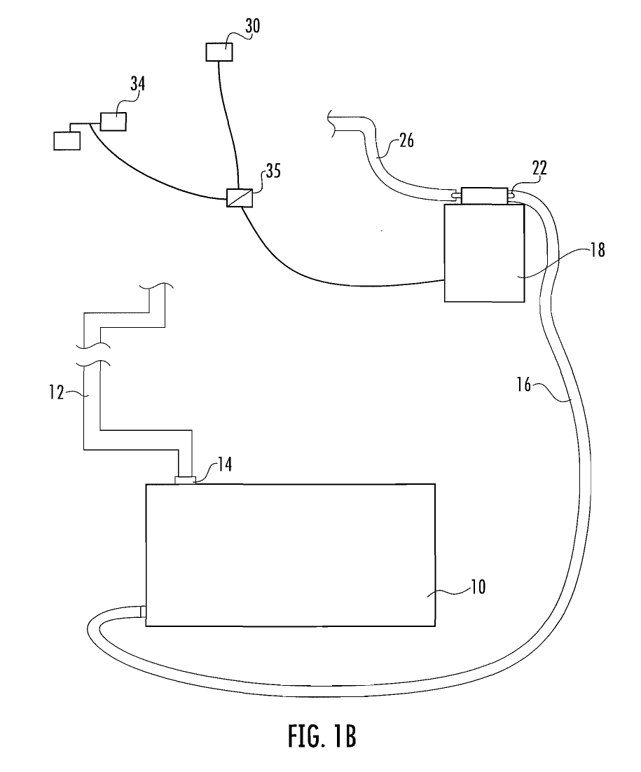

FIG. 1A illustrates a block diagram of a portion of an ice machine for dispensing flavored ice cubes in accordance with the instant invention. A container or beverage holding tank 10 is constructed and arranged to hold one or more beverages. Coupled to the beverage holding tank 10 are one or more channels, tubing, hoses, or the like for transporting liquids from a first location to the tank 10. For example, to fill the beverage holding tank 10, a fill hose 12 is coupled to the beverage holding tank through fitting 14. The fill hose 12, or an additional fill hose, not illustrated, may be used as a drainage hose thereby providing a means for recycling unused fluid within the ice maker back to the beverage holding tank 10. A first supply hose 16 fluidly connects the beverage holding tank 10 to a device for transferring the beverage to a flavored ice forming device, illustrated herein as a pump 18 through fittings 20 and 22. The pump 18 is fluidly connected to an existing feed line 24 via a second supply hose line 26 which connects to the pump 18 via fittings 28. An on/off switch 30 is electrically coupled to the pump 18 through electrical wiring 32. When activated, the pump pumps the beverage from the beverage holding tank 10 to the existing feed line 24, which in a preferred embodiment is pressurized. The feed line directs the fluid to a device for making flavored ice. One or more floats 34 may be used to detect the levels in the beverage holding tank 10 and electrically signal on/off commands to the pump through control circuitry 35. Alternatively, the pump 18 may be fluidly coupled directly to the device for making flavored ice through the second supply hose line 26, see FIG. 1B. In this embodiment, the beverage stored in the beverage holding tank 10 can be directly injected into the device for making flavored ice under a pressurized system. Control devices known to one of skill, such as the use of valves, such as solenoid valves, and floats, can be used to continuously and automatically fill the device for making flavored ice with the beverage as needed.

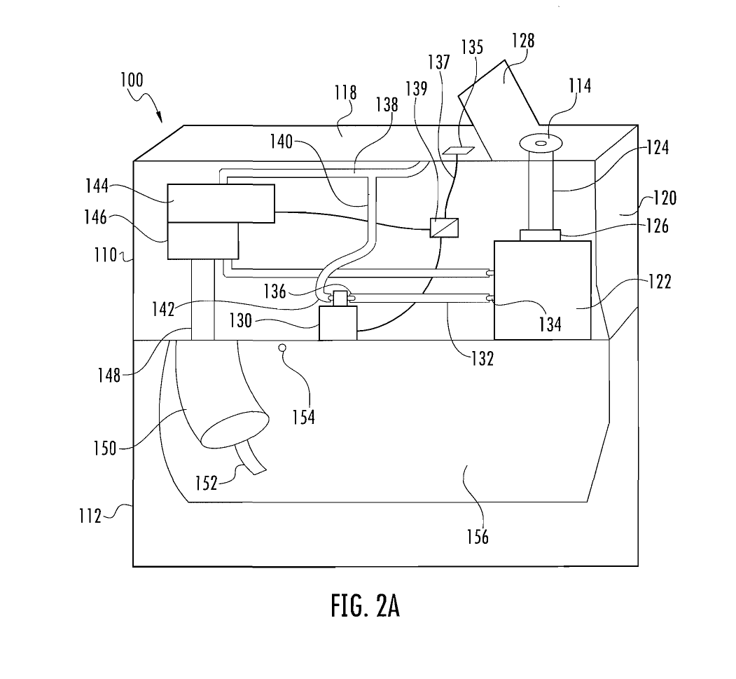

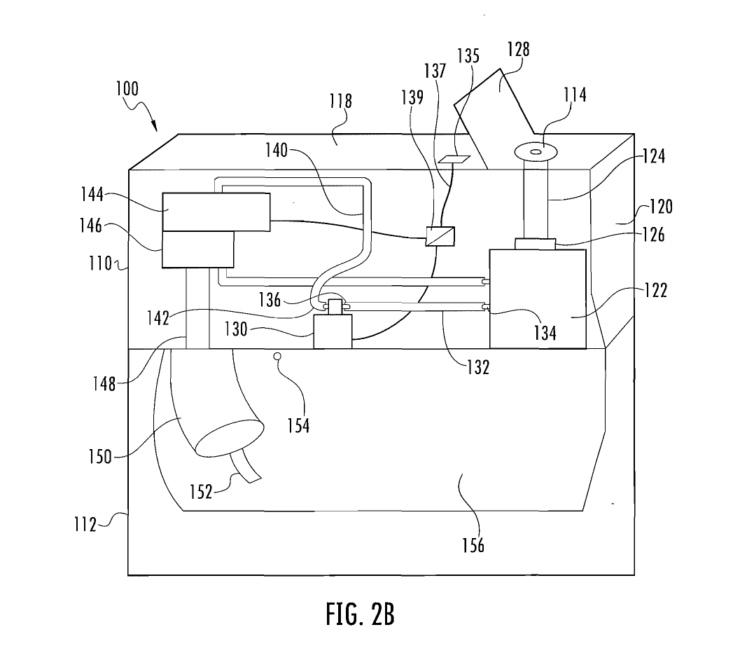

FIGS. 2A and 2B illustrate particular embodiments of the ice machine for dispensing flavored ice cubes in accordance with the instant invention, and is generally referred to herein as 100. The ice machine for dispensing flavored ice cubes 100 comprises an upper portion 110 and a lower portion 112. The upper portion 110 contains the internal parts, similar to that described in FIG. 1A or FIG. 1B of the ice machine for dispensing flavored ice cubes 100 that produces the flavored ice. To produce the flavored ice, a user pours a beverage, illustrated herein as coffee, into an opening 114 positioned along the first portion 110. The opening 114 placement is illustrated along the upper edge surface 118 of the upper portion 110, but may be placed along the side surface 120. The opening 114 is coupled to a beverage holding tank 122 via a channel or tubing 124. The tubing 124 is secured to the beverage holding tank via fittings 126. The beverage holding tank 122 is constructed and arranged to hold any liquid. The opening 114 may be constructed in the form of a funnel shape to provide easy transfer of the beverage to the beverage holding tank 122, thereby reducing loss of the beverage resulting from spillage. Optionally, the upper surface 118 may contain a door 128 constructed and arranged to enclose the opening 114 in order to prevent unintended fluids or other debris from entering the beverage holding tank 122.

The beverage holding tank 122 connects to a pump 130 via a first supply hose 132. While the first supply hose 132 is preferably made of stainless steel, other materials may be used as well. The first supply hose 132 connects to the beverage holding tank 122 and the pump 130 through fittings 134 and 136. The pump 130, which may be for example an 115V pump, must be sufficient to pump the beverage from the beverage holding tank 122 to an existing pressurized feed line 138. The pump is turned on by switching a power button 135 which is electrically coupled to the pump 130 via wiring 137. Control mechanisms, such as use of floats 139, may be utilized to detect the levels of the beverage stored in the beverage holding tank 122. The beverage is pumped to the existing feed line 138 through a second supply hose 140 connected to the pump 130 through a fitting 142. Fittings 126, 134, 136, and 142 may be any type of fitting known to one of skill in the art, including but not limited to 90 degree fittings or reducing fittings. Optionally, a thermal sensor (not illustrated) placed in the beverage holding tank 122 and electrically coupled to the pump 130 may prevent the pump 130 from operating if the beverage placed in the holding tank 122 is not at an optimal temperature. If, for example, freshly brewed coffee is placed in the holding tank, the pump will not activate until the coffee is at or near room temperature.

In an illustrative embodiment, the existing pressurized feed line 138 is coupled to an external water supply line (not illustrated). In this manner, the beverage is pumped into the pressurized feed line 138, mixing the water with the beverage. Alternatively, the ice maker 100 can be constructed such that the beverage is pumped into the pressurized feed line 138 without mixing with any water. In another alternative embodiment, the ice maker 100 may be constructed so that the beverage stored in the beverage tank 122 is pressurized, through activation of pump 130 to flow directly into an ice cube maker 144 through the second supply hose 140.

The beverage and/or the beverage/water mixture are pressurized to flow into an ice cube maker 144. The ice cube maker 144 can be a non-commercial grade ice maker which may include an electric motor, electrical circuitry, electrically operated fluid valves, and an electric heating unit, known to one of skill in the art, and makes ice by filling a tray and freezing all the beverage at once. Alternatively, the ice cube maker 144 is a commercial grade ice cube maker adapted to freeze the beverage layer by layer to form clear flavored ice. After the fluid is placed into the ice maker 144, the fluid is frozen, resulting in flavored ice cubes, i.e. ice cubes made of coffee or other beverages. The flavored ice cubes are then released from the ice cube maker and transferred to a storage bin 146. The ice cube maker 144 may contain a cutting mechanism (not illustrated) to form ice chips or ice flakes.

A channel, passageway, hose, or the like, illustrated generally as 148 is coupled to a dispensing unit 150. The dispensing unit 150 is preferably located on the lower portion 112. The flavored ice may be dispensed from the ice cube storage bin 146 by contacting a lever 152 or button 154. Upon activation, the ice is dispensed from the storage bin 146, through the ice passageway 148 and into a beverage holding container (not illustrated). In addition to providing an area 156 for which a container, such as a glass, pitcher, or the like, can access the flavored ice cubes, the bottom portion 112 also provides support for the upper portion 110.

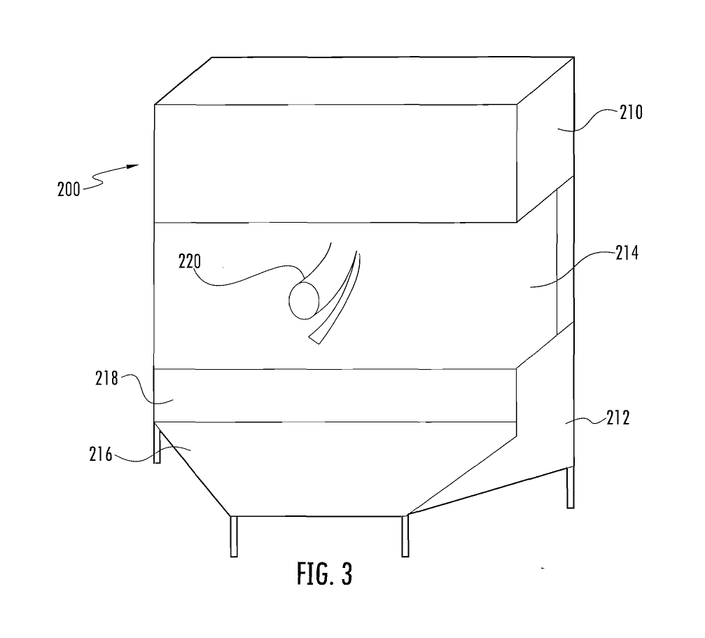

FIG. 3 is a front perspective view of an alternative embodiment of the ice machine for dispensing flavored ice cubes in accordance with the instant invention, generally referred to as 200. The ice machine for dispensing flavored ice cubes 200 contains an upper portion 210, a lower portion 212, and a middle portion 214. The upper portion 210 may contain all the same internal components as described for the ice machine for dispensing flavored ice cubes 100. In addition to providing support for the upper portion 210, the lower portion 212 may contain an additional storage bin 216. If the ice maker component is placed within the upper portion 210, a second passageway (not illustrated) leading from the ice maker to the storage bin 216 would be used. A hinged door 218 provides the user access to the stored, flavored ice cubes. In addition to dispensing flavored ice cubes from the dispensing unit 220 positioned in the middle portion 214, a large amount of ice cubes can be accessed quickly and easily by using the storage bin 216, reducing the amount of time needed to obtain a large amount of flavored ice cubes. Given the large amount of flavored ice stored within the storage bin 216, additional pumps may be used to recycle melted flavored ice back to the beverage holding tank. While the inner components of the ice maker 200 have been described in the upper portion 210 only, one or more components may be placed within the lower portion 212, or in both the upper and lower portions.

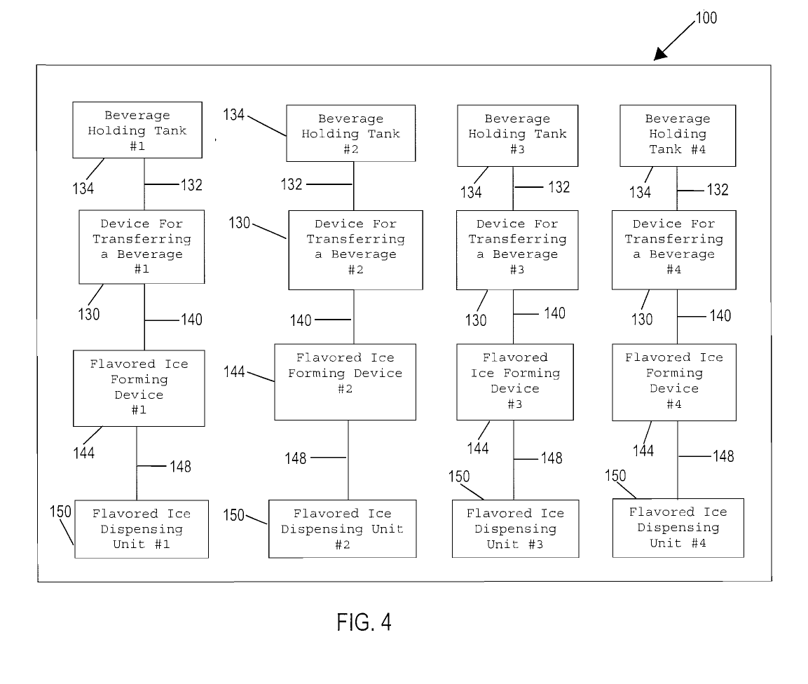

The ice machine for dispensing flavored ice cubes in accordance with the instant invention may be constructed of multiple beverage holding tanks, pumps, ice cube makers, storage bins, and dispensing units so that the unit can dispense and/or store more than one type of flavored ice cubes, see FIG. 4. For example, the unit may contain four beverage holding tanks. Each of the beverage holding tanks could hold different beverages, such as coffee, carbonated sodas, lemonade, and one or more alcohol drinks. Each beverage holding tank would be connected to a separate pump, ice maker, storage bin, and dispensing unit. This arrangement allows different beverages to freeze at different temperatures if needed, and further provides the user the ability to independently obtain a plurality of differently flavored ice cubes depending on the beverage the customer orders.

The ice machine for dispensing flavored ice cubes in accordance with the instant invention may also be adapted to create a beverage within the device. For example, the device may be adapted to contain a plurality of dispensing tubes that are functionally connected to provide a beverage such as carbonated soft drink like COCA-COLA or PEPSI, or non-carbonated drinks such as lemonade, similar to standard soda dispensing units or soda fountains used in restaurants. The device may also be adapted to brew coffee or tea and dispense the freshly brewed coffee or tea into the beverage holding tank. This action may be performed manually by a user engaging a power switch which begins the brewing process or through on board control devices such as a microprocessor or other electronic circuitry designed to automatically begin the brewing process. In either case, once the drink is brewed, it is directed into the beverage holding tank for development of the flavored ice.

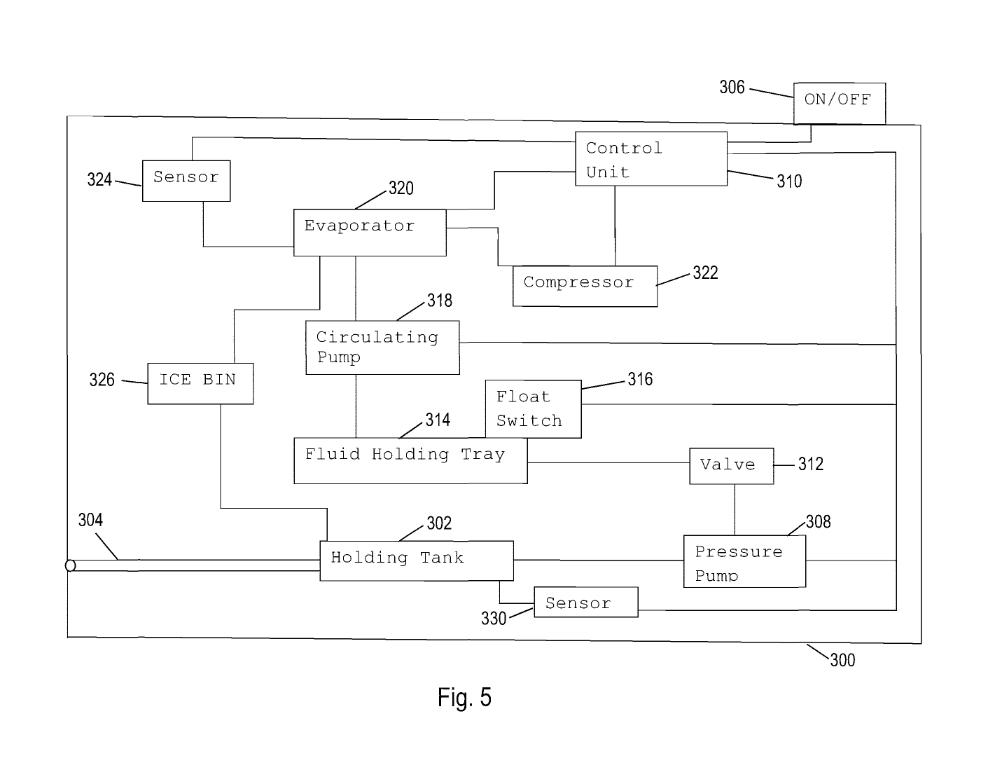

FIG. 5 illustrates the ice machine for dispensing flavored ice cubes in accordance with embodiments as described prior, with additional features, in order to further illustrate how flavored ice cubes are made within the devices. Each of the components described will form a component of the flavored ice cube making or dispensing machine, referred to generally as a machine for dispensing flavored ice cubes 300. To start, a user adds a flavored beverage to holding tank 302. The holding tank 302 is constructed and arranged to hold one or more flavored beverages. Coupled to the holding tank 302 may be a fill channel 304 for transporting the flavored beverage from a first location into the holding tank 302. Once the machine for dispensing flavored ice cubes 300 is powered on by switching the on/off power switch 306 to the “ON” position, pressure pump 308 is activated as the control unit 310, such as a microprocessor, is programmed to activate the pressure pump 308. Valve 312 is opened, for a pre-determined time period, preferably 45 seconds. This allows the pressurized flavored beverage within the holding tank 302 to fill a fluid holding tray 314. The amount of flavored beverage placed within the fluid holding tray 314 may be controlled by time, or use of a float switch 316.

Once the fluid holding tray 314 is filled to a predetermined level, the second pump, circulating pump 318, is activated. The circulating pump circulates fluid into the ice maker component (fluid freezing mechanism or ice generator of a flavored ice making device) of the machine for dispensing flavored ice cubes 300. As shown in the diagram, the ice making component includes an evaporator plate 320. Compressor 322 activates to a cooling mode. The circulating pump 318 is programmed to continuously to circulate the flavored beverage for a time period which results in the flavored beverage freezing. One or more layers of flavored ice are formed. Preferably, the circulating pump is run for a period of at least minutes, and more preferably, for a period of 12 to 14 minutes. A sensor 324 is configured to sense the thickness of the ice forming on the evaporator. Once the ice reaches a predetermined thickness, the compressor 322 activates to a heat mode, thereby beginning the ice harvest phase. As the compressor heats, the flavored beverage ice formed on the evaporator melts slightly, allowing the flavored ice to fall off and into a flavored ice storage bin 326. The flavored ice storage bin is coupled to the holding tank 302 via tubing 328. This connection allows for recycling melted flavored ice back to the beverage holding tank.

Using the current process, any flavored beverage, such as any liquid that freezes at a temperature that is different than water can be formed. As an illustrative example, frozen coffee ice cubes can be formed. A user can pour coffee into holding tank 302. If the coffee is still hot, a temperature sensor 330 may be used to measure the temperature of the liquid. If the liquid is at a temperature that is too hot, the control unit 310 will prevent the flavored ice making device 300 from starting the process of making flavored ice until a predetermined temperature is achieved. Once the liquid coffee is in the holding tank 302, the flavored ice making device 300 may be turned on. Pressure pump 308 is activated, moving pressurized coffee to valve 312. Valve 312 is opened, allowing the coffee to fill the fluid holding tray 314 until float switch 316 is activated, closing valve 312. The circulating pump 318 starts circulation of the coffee, running the coffee over the evaporator 320. Compressor 322 starts the cooling process. Both the circulating pump 318 and the compressor 322 are run for a time period sufficient to form frozen coffee, typically between 12 and 14 minutes. The coffee freezes to a thickness determined by sensor 324. At a predetermined thickness, the compressor 322 reverse cycles and begins to heat, resulting in the release of the iced coffee from evaporator 320. The frozen coffee is dumped into ice bin 326. Any iced coffee that melts is transferred to holding tank 302 and used for additional ice coffee making cycles.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of producing flavored ice comprising:
providing a flavored liquid to be formed into a frozen state;
storing said flavored liquid in a first holding tank;
pressurizing said flavored liquid to form a pressurized flavored liquid;
moving said pressurized liquid from said first holding tank to a fluid holding tray;
forming a flavored ice by circulating said flavored liquid over an ice generator of a flavored ice making device.

2. The method of producing flavored ice according to claim 1 wherein said circulating said flavored liquid over an ice generator includes a circulating cycle of between 12 and 14 minutes.

3. The method of producing flavored ice according to claim 1 wherein forming a flavored ice by circulating said flavored liquid over an ice generator includes the steps of:
using a pump to transfer said flavored liquid stored within fluid holding tray to an ice generator evaporator;
continuously circulating said flavored liquid over said ice generator evaporator for a predetermined time period to form one or more layers of frozen flavored liquid.

4. The method of producing flavored ice according to claim 3 wherein said step of continuously circulating said flavored liquid over said ice generator evaporator occurs for a period of at least 12 minutes.

5. The method of producing flavored ice according to claim 3 wherein said step of continuously circulating said flavored liquid over said ice generator evaporator occurs for a period of between 12 and 14 minutes.

6. The method of producing flavored ice according to claim 3 further including the step of measuring the thickness of said one or more layers of frozen flavored liquid formed on said ice generator evaporator.

7. The method of producing flavored ice according to claim 3 further including the step of harvesting said one or more layers of frozen flavored liquid formed on said ice generator evaporator.

8. The method of producing flavored ice according to claim 7 further including the step of transferring melted flavored liquid formed from said harvested one or more layers of frozen flavored ice to said first holding tank.

9. The method of producing flavored ice according to claim 1 wherein said flavored liquid is a liquid which has a freezing temperature that is different than the freezing temperature of water.

10. The method of producing flavored ice according to claim 1 wherein said flavored liquid is coffee, coffee based beverages, or a flavored coffee.

11. The method of producing flavored ice according to claim 1 wherein said flavored liquid is made from tea, tea-based beverages, or flavored tea.

12. The method of producing flavored ice according to claim 1 wherein said flavored liquid is made from a carbonated soft drink.
